(19) United States
(12) Patent Application Publication
(10) Pub. No.: US 2008/0189869 A1
(43) Pub. Date: Aug. 14, 2008

(54) SECURING UNIT

(75) Inventors: Larry R. Cox, Austin, TX (US); Martha M. Barrick, Leander, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/672,731

(22) Filed: Feb. 8, 2007

(51) Int. Cl. B25F 1/02

(52) U.S. Cl. 7/167

(57) ABSTRACT

Various embodiments of the present invention provide a securing unit for holding and securing a marker in close proximity to an end section of a conduit. The securing unit is capable of holding a marker inside a conduit, in close proximity to the end section of the conduit. The securing unit holds and secures a marker in the end section of the conduit which may be in any orientation with respect to a horizontal or vertical plane. An end cap may be used for sealing the end section of the conduit and restricting the movement of the securing unit.

### BACKGROUND OF THE INVENTION

The present invention relates generally to a securing unit. More specifically, the invention relates to a securing unit for securing a marker in close proximity to an end section of a conduit.

Conduits of varying sizes are typically used for housing utility cables, including cables for electrical power and telephone utilities. Telephony cables may consist of copper strands and/or optical fibers. Conduits often are buried underground, and cables may be installed at the time of burial or at some later date. A buried conduit may be exposed to various environmental forces, such as soil erosion or movement and water intrusion.

Once conduits are buried, it may be necessary to locate the end sections of buried conduits in order to install fiber or copper cables, connect them to other conduits, terminate one or more cables, extend the cables passing through the conduits or the like. It is therefore important to identify with as much accuracy as possible the vicinity of an end section of a buried conduit to reduce the excavating cost and efforts. Accurately locating the end section of a buried conduit can also avoid inadvertently digging up and damaging other utility lines that may be buried in close proximity to the conduit.

Various types of marking devices (commonly referred as “markers”) are sometimes used to locate the end sections of a buried conduit. Visual markers, for example, may be placed over the ground, metal objects may be placed next to the conduit, and electronic markers may be buried near the conduit end. Markers may also be placed in the conduit near the end sections. Several drawbacks attend the use of such markers. Visual markers may get displaced, while metal objects along the ground may reduce accuracy while detecting the end sections of the conduit. Electronic markers may get displaced due to backfilling, soil erosion, movement or the like. Markers loosely placed inside conduits may be get displaced and come to rest far from the end sections of the conduits. As a result, it can sometimes be difficult to accurately locate the end sections of the conduits even with use of markers.

There is therefore a need for a securing unit for housing and securing a marker in close proximity to an end section of a conduit.

### SUMMARY OF THE INVENTION

Various embodiments of the present invention provide a securing unit for housing and securing a marker in close proximity to an end section of a conduit.

In one embodiment of the invention, the securing unit comprises an annular ring capable of supporting a marker. The annular ring is placed over an end section of a conduit and captivated with an end cap to secure the marker.

In another embodiment of the invention, the securing unit comprises one or more flexible legs attached to an annular ring. The annular ring supports a marker, while the end of each of the one or more flexible legs is attached to an end section of a conduit to hold and secure the marker.

In yet another embodiment of the invention, the securing unit may comprise an annular ring attached to two or more radial arms. The annual ring supports at least one marker. The radial arms extend over an end section of a conduit or can be folded inside a conduit to secure the marker.

In another embodiment of the invention, the securing unit is made of a flexible material having a circular loop at the apex of the securing unit. A marker is housed in the circular apex, while ends of the flexible material are attached to an end section of a conduit to secure the marker.

In various embodiments of the invention, the securing unit secures a marker inside or outside a conduit in close proximity to the end section of the conduit. As a result, the end section of the conduit may be accurately located. The securing unit may be used to secure one or more types of markers, and may be used in conduits of one or more diameters.

Other objects and advantages of the present invention will become apparent upon reading the following detailed description and appended claims and upon reference to the accompanying drawings.

### BRIEF DESCRIPTION OF THE DRAWINGS

FIG. 1a depicts a securing unit with flexible legs for housing a marker in accordance with one embodiment of the invention.

FIG. 1b depicts a securing unit with flexible legs securing a marker in close proximity to an end section of a conduit in accordance with an embodiment of the invention.

FIG. 2a depicts a securing unit designed as an annular ring for supporting a marker in accordance with an embodiment of the invention.

FIG. 2b depicts a securing unit designed as an annular ring for securing a marker in close proximity to an end section of a conduit in accordance with another embodiment of the invention.

FIG. 3 depicts a securing unit securing a marker in close proximity to an end section of a conduit in accordance with an embodiment of the invention.

FIG. 4a depicts a securing unit with radial arms for housing a marker in accordance with an embodiment of the invention.

FIG. 4b depicts a securing unit with radial arms for housing a marker in accordance with another embodiment of the invention.

FIG. 4c depicts a marker being supported by a securing unit with radial arms housing a marker in accordance with another embodiment of the invention.

FIG. 4d depicts a securing unit with radial arms securing a marker in close proximity to an end section of a conduit in accordance with another embodiment of the invention.

FIG. 4e depicts a securing unit with radial arms securing a marker in close proximity to an end section of a conduit in accordance with another embodiment of the invention.

### DETAILED DESCRIPTION OF PREFERRED EMBODIMENTS

Various embodiments of the invention provide a securing unit for securing a marker in close proximity to an end section of a conduit. The end section of the conduit may be in any orientation with respect to a horizontal or vertical plane. The securing unit is capable of housing a marker and maintaining its position near the end of the conduit by entrapment or by exerting a force on the end section of the conduit.

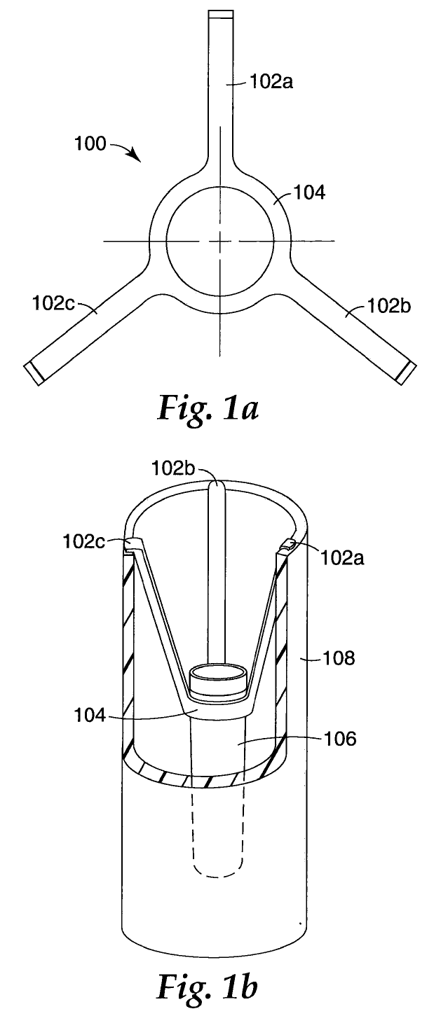

FIG. 1a depicts securing unit 100 with flexible legs for securing a marker in accordance with one embodiment of the invention. Securing unit 100 includes three flexible legs 102a, 102b and 102c and armular ring 104. One end of each of flexible legs 102a, 102b and 102c is attached to annular ring 104. Annular ring 104 is sized to support a marker.

A marker may be supported in annular ring 104 by placing the marker in the central hole of annular ring 104. Securing unit 100 may be placed in a conduit and an end of each of flexible legs 102a, 102b and 102c may be attached to an end section of the conduit. Flexible legs 102a, 102b and 102c may exert a force on the end section of the conduit to secure the marker in close proximity to the end section of the conduit.

In various embodiments of the invention, securing unit 100 may include two or more flexible legs. An end cap may be used to seal the end section of the conduit. Securing unit 100 may be removable from conduit 108 and reused in another conduit application. Securing unit 100 may alternatively be permanently attached with conduit 108 by welding, employing adhesive or the like. Securing unit 100 may be constructed from plastic materials such as polyethylene, vinyls, polypropylene, polyvinyl chloride, and combinations thereof. Materials such as metals, and composites would also be suitable for this purpose.

FIG. 1b depicts securing unit 100 with flexible legs securing a marker in close proximity to an end section of a conduit. FIG. 1b includes securing unit 100, marker 106, and conduit 108. Marker 106 is supported in annular ring 104. An end of each of flexible legs 102a, 102b and 102c is attached to an end section of conduit 108 at an angle. Flexible legs 102a, 102b and 102c exert a force on the end section of conduit 108 to restrict the movement of marker 106. In various embodiments of the invention, an end of each of flexible legs 102a, 102b and 102c is attached to an end section of conduit 108 at an angle of about 90 degrees.

In various embodiments of the invention, an end cap may be used to seal the end section of conduit 108. Marker 106 may be a Near-Surface Marker, an electronic marker, a marker with a radio frequency identification (RFID) tag, an electronic ball marker or the like. In one embodiment of the invention, marker 106 may be a small form factor electronic marker.

Marker 106 may be removable from securing unit 100. Marker 106 may alternatively be permanently attached to securing unit 100 by welding, employing adhesives or the like.

In an embodiment of the invention, the outside diameter of conduit 108 may be between about 0.02 meters and about 0.3 meters. Securing unit 100 may be sized such that the outside diameter of annular ring 104 is less than the inside diameter of conduit 108.

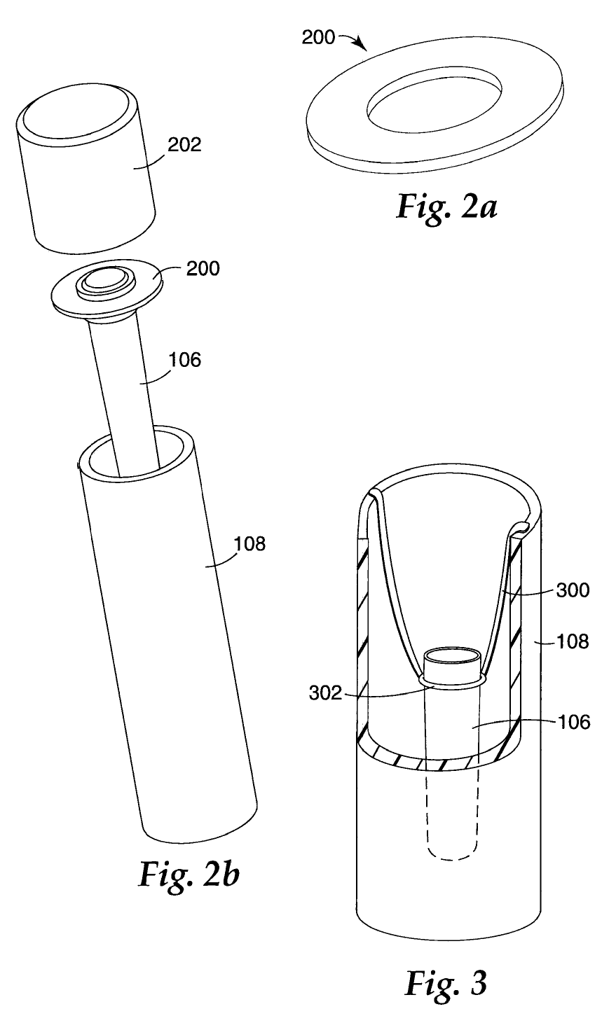

FIG. 2a depicts securing unit 200 designed as an annular ring for securing a marker in accordance with another embodiment of the invention. Securing unit 200 is designed as an annular ring comprising a central hole. A marker may be housed in the central hole of securing unit 200.

Securing unit 200 may be placed over an end section of a conduit. An end cap may be used to restrict the movement of the securing unit and seal the end section of the conduit. Securing unit 200 may be sized such that the outside diameter of securing unit 200 is between the outside diameter and the inside diameter of the conduit. The outside diameter of securing unit 200 may be between about 0.02 meters and about 0.3 meters. Securing unit 200 may be constructed from plastic materials such as polyethylene, polypropylene, vinyls, poly vinyl chloride, and combinations thereof. Materials such as metals, and composites would also be suitable for this purpose.

FIG. 2b depicts a marker installed in a securing unit 200 designed as an annular ring for securing a marker in close proximity to an end section of a conduit in accordance with another embodiment of the invention. FIG. 2b includes securing unit 200, marker 106, conduit 108 and end cap 202.

Marker 106 is housed in the central hole of securing unit 200. Securing unit 200 may be placed over an end section of conduit 108 in order to secure marker 106 in close proximity to the end section of conduit 108. End cap 202 may be used to seal the end section of conduit 108. Securing unit 200 may be placed over an end section of conduit 108 such that marker 106 is away from conduit 108. An end cap having an appropriate cavity for marker 106 may be used to seal the end section of conduit 108.

Marker 106 may be removable from securing unit 200 and reused in another location. Marker 106 may alternatively be permanently attached with securing unit 200 by welding, employing adhesives or the like.

In an embodiment of the invention, the outside diameter of conduit 108 is about 0.02 meters. In various embodiments of the invention, the outside diameter of the conduit may be between about 0.02 meters and about 0.3 meters.

FIG. 3 depicts a securing unit 300 securing a marker in close proximity to an end section of a conduit in accordance with another embodiment of the invention. FIG. 3 includes securing unit 300, marker 106 and conduit 108. Securing unit 300 is constructed from a flexible material and is substantially “V” shaped. Securing unit 300 is arranged to form a circular loop 302 at the apex of securing unit 300. Marker 106 is housed in circular loop 302. The ends of securing unit 300 are attached with an end section of conduit 108 at an angle. The ends of securing unit 300 exert a force on the end section of conduit 108 to secure marker 106 in close proximity to the end section of conduit 108. In various embodiments of the invention, the ends of securing unit 300 are attached to the end section of conduit 108 at an angle of about 90 degrees.

In an embodiment of the invention, securing unit 300 may be constructed from a spring type material. Spring tension on the ends of securing unit 300 may be created by a squeezing effect on the wall of conduit 108. A frictional resistive force may thereby be created in order to restrict the movement of marker 106 and secure marker 106 in close proximity to the end section of conduit 108. Securing unit 300 may be constructed from plastic materials such as polyethylene, polypropylene, vinyls, poly vinyl chloride, and combinations thereof. Materials such as metals, and composites would also be suitable for this purpose.

Marker 106 may be removable from securing unit 300. Marker 106 may alternatively be permanently attached with securing unit 300 by welding, employing adhesives or the like.

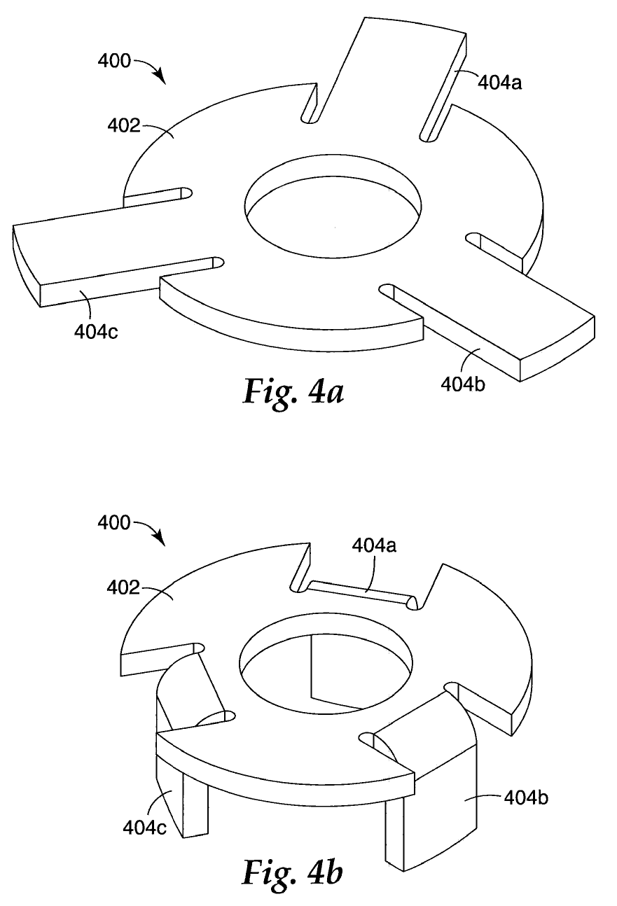

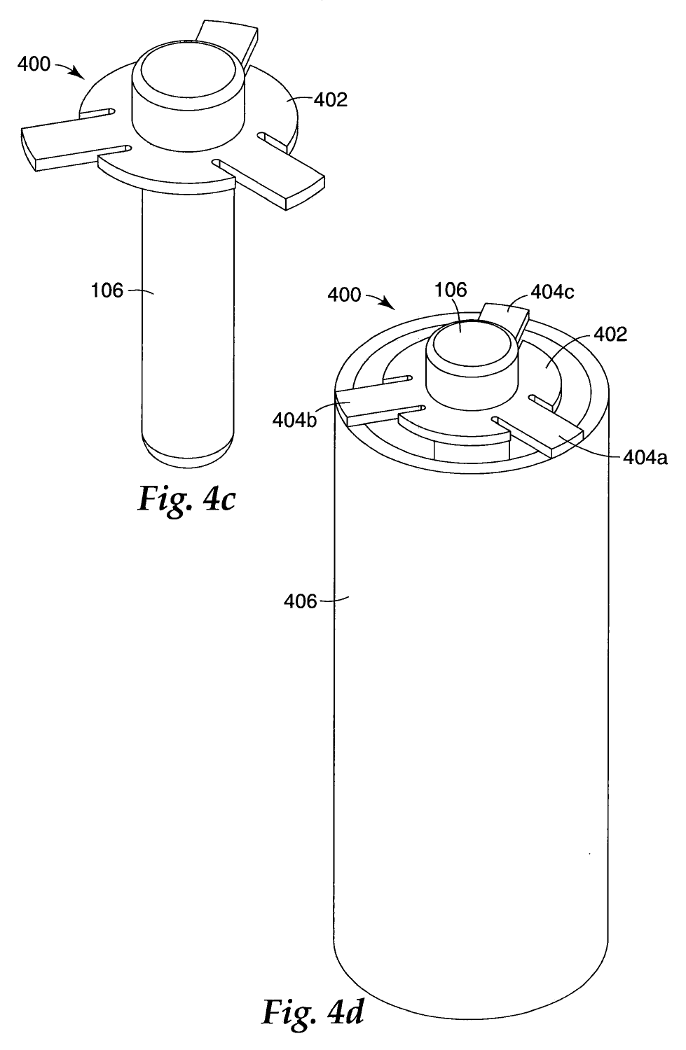

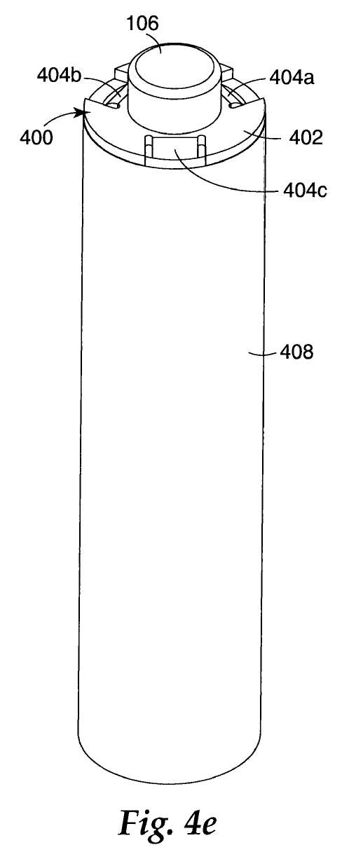

FIG. 4a depicts a securing unit 400 with radial arms for securing a marker in accordance with another embodiment of the invention. Securing unit 400 includes annular ring 402 and radial arms 404a, 404b and 404c. Annular ring 402 includes a central hole and is attached with radial arms 404a, 404b and 404c. Each of radial arms 404a, 404b and 404c extend outwardly from annular ring 402.

In various embodiments of the invention, radial arms 404a, 404b and 404c may extend outwardly from annular ring 402 or may be folded depending on the outside diameter of a conduit.

Securing unit 400 may be constructed from plastic materials such as polyethylene, polypropylene, vinyls, poly vinyl chloride, and combinations thereof. Materials such as metals, and composites would also be suitable for this purpose.

Securing unit 400 may be placed over conduits of one or more outside diameters. Depending on the outside diameter of a conduit, radial arms 404a, 404b and 404c may be extended outwardly from annular ring 402 and placed over an end section of a conduit. Securing unit 400 may be sized such that the outside diameter of the annular ring is less than the inside diameter of the conduit.

Alternatively, depending on the outside diameter of a conduit, radial arms 404a, 404b and 404c may be folded and annular ring 402 may be placed over an end section of the conduit. Radial arms 404a, 404b and 404c may then be contained inside the conduit, as illustrated in FIG. 4b. Securing unit 400 may be sized such that the outside diameter of annular ring 402 is between the outside diameter and the inside diameter of the conduit.

FIG. 4b depicts securing unit 400 with radial arms for housing a marker in accordance with another embodiment of the invention. Radial arms 404a, 404b and 404c are folded.

A marker may be housed in the central hole of annular ring 402. Annular ring 402 may be placed over an end section of a conduit. Radial arms 404a, 404b and 404c may then be contained inside the conduit. Annular ring 402 movement is restricted by the installation of the end cap, thus securing the marker. The outside diameter of annular ring 402 may be between the outside diameter and the inside diameter of the conduit. An end cap may be used to seal the end section of the conduit.

FIG. 4c depicts securing unit 400 with radial arms housing a marker in accordance with another embodiment of the invention. Marker 106 is supported in the central hole of annular ring 402. Marker 106 may be removable from securing unit 400. Marker 106 may alternatively be permanently attached with securing unit 400 by welding, employing adhesives or the like.

FIG. 4d depicts securing unit 400 with radial arms securing a marker in close proximity to an end section of a conduit, in accordance with another embodiment of the invention. FIG. 4d includes securing unit 400, marker 106 and conduit 406. Marker 106 is housed in the central hole of annular ring 402. Radial arms 404a, 404b and 404c are extended outwardly from annular ring 402. Securing unit is placed over an end section of conduit 406 by placing radial arms 404a, 404b and 404c over the end section. Radial arms 404a, 404b and 404c prevent the marker from sliding inside the conduit and installation of the end cap restricts the movement of the securing unit 400 thus preventing the marker from exiting the conduit.

In various embodiments of the invention, an end cap may be used to seal the end section of conduit 406. The outside diameter of annular ring 402 may be less than the inside diameter of conduit 406.

Securing unit 400 may be placed over the end section of conduit 406 such that marker 106 is in a direction away from conduit 406. An end cap is used to seal the end section of the conduit, so that marker 106 is in close proximity to the end section of the conduit.

In the illustrated embodiment, the outside diameter of conduit 406 is about 0.05 meters. In various embodiments of the invention, securing unit 400 may be sized to secure a marker in close proximity to an end section of one or more conduits with an outside diameter between about 0.02 meters and about 0.3 meters.

FIG. 4e depicts securing unit 400 with radial arms folded securing a marker in close proximity to an end section of a conduit, in accordance with another embodiment of the invention. FIG. 4e includes securing unit 400, marker 106 and conduit 408. Marker 106 is housed in the central hole of annular ring 402. Radial arms 404a, 404b and 404c are folded. Securing unit 400 is placed over an end section of conduit 408 by placing annular ring 402 over conduit 408. Radial arms 404a, 404b and 404c are contained inside conduit 408. Annular ring 402 movement is restricted by the installation of the end cap, thus securing the marker.

In various embodiments of the invention, an end cap may be used to seal the end section of conduit 408. The outside diameter of annular ring 402 may be between the outside diameter and the inside diameter of conduit 408.

In the illustrated embodiment, the outside diameter of conduit 408 is approximately 0.03 meters. In various embodiments of the invention, securing unit 400 may be sized to secure a marker in close proximity to an end section of one or more conduits with an outside diameter between about 0.02 meters and about 0.3 meters.

Various embodiments of the invention have one or more of the following advantages.

The securing unit secures a marker in an end section of a conduit which may be in any orientation with respect to a horizontal or vertical plane. As a result, the end section may be accurately located. This reduces the time and effort involved in digging while installing fiber or copper cables through a buried conduit.

The securing unit is capable of securing one or more types of markers in close proximity to an end section of a conduit. Further, various embodiments of the securing unit may be employed in conduits of one or more inside diameters, providing in a reduction of necessary inventory for a service provider, as the need to order separate stock numbers for each conduit size is reduced. This results in reduced space requirements for warehouse stocking as well as during transportation to the site where conduits may be buried.

In various embodiments of the invention, the securing unit may be removable from an end section of a conduit and may be re-used in another conduit having similar or different inside diameter. Also, the marker housed in a securing unit may be removable and re-useable.

Various embodiments of the invention provide for installation of a marker in close proximity to an end section of a conduit in the same construction step as sealing the end section of the conduit with an end cap. Therefore, the requirement of a separate construction process of placing an external marker is eliminated.

The securing unit is simple to use, and requires no tools for installation. Further, the application of an end cap to seal an end section of a conduit restricts the movement of the securing unit in the conduit while protecting the conduit from contamination by preventing water or dirt intrusion.

The securing unit of various embodiments of the invention may be made using modern machine stamping processes, injecting molding, etc., thereby resulting in reduced production costs. Further, the securing unit is a single component and therefore requires no or reduced cost of assembly.

The marker holding mechanism is mechanical, by the application of force, and does not involve costly, time-consuming steps with variability due to the environment, such as adhesives, cleaning or wet process steps in assembly or in field operations.

While various embodiments of the invention have been illustrated and described, it will be clear that the invention is not limited to these embodiments only. Numerous modifications, changes, variations, substitutions and equivalents will be apparent to those skilled in the art without departing from the spirit and scope of the invention as described in the claims.

We claim:

1. A securing unit for securing a marker in close proximity to an end section of a conduit, the securing unit holding the marker, the securing unit exerting a force on the end section of the conduit to restrict the movement of the marker.

2. The securing unit of claim 1 comprising:
a. an annular ring, the annular ring supporting the marker; and
b. one or more flexible legs, an end of each of the one or more flexible legs is attached with the end section of the conduit, another end of each of the one or more flexible legs is attached with the annular ring.

3. The securing unit of claim 2, wherein each of the one or more flexible legs are attached to the conduit at an angle.

4. The securing unit of claim 1 comprising:
a. an annular ring, the annular ring supporting a marker; and
b. two or more radial arms, the two or more radial arms being attached with the annular ring.

5. The securing unit of claim 4, wherein the outside diameter of the annular ring is between the outside diameter and the inside diameter of the conduit.

6. The securing unit of claim 4, wherein the outside diameter of the annular ring is less than the inside diameter of the conduit.

7. The securing unit of claim 4, wherein each of the two or more radial arms is foldable.

8. The securing unit of claim 4, wherein each of the two or more radial arms is flexible beyond the outer diameter of the annular ring.

9. The securing unit of claim 1, wherein the securing unit is made of a flexible material.

10. The securing unit of claim 9, wherein the securing unit is attached to the end section of the conduit at an angle.

11. The securing unit of claim 9, wherein the securing unit is substantially ‘v’ shaped.

12. The securing unit of claim 9, wherein the flexible material is arranged to form a circular loop at the apex of the securing unit for housing the marker.

13. The securing unit of claim 1, wherein the securing unit secures the marker inside the conduit.
